(19) United States
(12) Patent Application Publication
(10) Pub. No.: US 2026/0331398 A1
(43) Pub. Date: Oct. 22, 2026

(54) KEY PRODUCTION METHOD, KEY STRUCTURE, KEY DEVICE, AND PROTECTIVE CASE

(71) Applicant: SHENZHEN XINPAIQUWAN TECHNOLOGY CO., LTD., SHENZHEN (CN)

(72) Inventors: HUAIJIA XU, SHENZHEN (CN); TAO ZHONG, SHENZHEN (CN); XI LI, SHENZHEN (CN)

(21) Appl. No.: 19/728,558

(22) Filed: Jul. 2, 2026

Related U.S. Application Data
(63) Continuation-in-part of application No. 19/314,267, filed on Aug. 29, 2025.

(30) Foreign Application Priority Data
Sep. 14, 2024 (CN) 202422254076.9
Aug. 28, 2025 (CN) 202511216081.3

(51) Int. Cl. H01H 13/14; A45C 11/00; H01H 11/00

(52) U.S. Cl. CPC H01H 13/14; A45C 11/00; H01H 11/00

(57) ABSTRACT

A key structure includes a conductive member and an insulating member surrounding the conductive member. The insulating member includes a main body, an elastic arm, and a buffer portion connected in sequence, the buffer portion is connected to the conductive member, an extension direction of the buffer portion is arranged at an angle to an extension direction of the elastic arm, and the extension direction of the elastic arm is arranged at an angle to an extension direction of the main body.

### CROSS-REFERENCE TO RELATED APPLICATIONS

This application is a continuation-in-part of U.S. patent application No. 19/314,267, filed on Aug. 29, 2025; and claims priority of Chinese patent application CN202511216081.3, filed on Aug. 28, 2025, the entire contents of which are incorporated herein by reference.

### TECHNICAL FIELD

The present disclosure relates to the technical field of keys, and in particular, to a key production method, a key structure, a key device, and a protective case.

### BACKGROUND

In existing silicone keys used for touch screens, when a user presses a key, the key is electrically connected to the touch screen to control the touch screen. In a production process of silicone keys, an insulating silicone part is usually produced first, followed by injection molding of a conductive silicone part onto the insulating silicone. In the above process, excessive conductive silicone material is often used, causing the conductive silicone to overflow onto the insulating silicone, which affects the elastic properties of the insulating silicone and consequently impairs user experience.

Therefore, a production solution is adopted in which the conductive silicone part is produced first, and then the insulating silicone part is injection-molded around the conductive silicone part. In this solution, a portion of the insulating silicone part adjacent to the conductive silicone part forms an elastic arm that is arranged at an angle to the main body. Because the elastic arm is arranged at an angle to the main body, during injection molding of the insulating silicone part, the insulating silicone may overflow onto an upper surface of the conductive silicone part due to inertia. As a result, when a user touches the upper surface of the conductive silicone part, an electrical connection with the conductive silicone part and the touch screen cannot be established, and the user is unable to control the touch screen via the silicone key, rendering the key's control function ineffective.

In order to solve shortcomings in existing technologies, the present disclosure is to provide a key production method, a key structure, a key device, and a protective case to solve above technological problems.

A key structure includes a conductive member and an insulating member surrounding the conductive member. The insulating member includes a main body, an elastic arm, and a buffer portion connected in sequence, the buffer portion is connected to the conductive member, an extension direction of the buffer portion is arranged at an angle to an extension direction of the elastic arm, and the extension direction of the elastic arm is arranged at an angle to an extension direction of the main body.

Beneficial Effects of the present disclosure: By arranging the third portion that is arranged at an angle to the second portion in the gap to be filled, the insulating silicone rubber is buffered when passing through the second portion and cannot directly overflow onto the first end or the second end of the conductive member, thereby preventing the insulating silicone rubber from overflowing onto the two ends of the conductive member and ensuring the conductive performance of the conductive member. In addition, the arrangement of the third portion allows the part of the conductive member cut off by the groove to enter the third portion, preventing the cut-off part of the conductive member from directly entering the second portion, thus ensuring the elastic performance of the insulating silicone rubber produced in the second portion and guaranteeing a good user experience.

### BRIEF DESCRIPTION OF THE DRAWINGS

To more clearly illustrate technical solutions in the embodiments of the present disclosure or in the prior art, the following briefly introduces drawings required for description of the embodiments or the prior art. Obviously, the drawings in the following description are only some embodiments of the present invention. For those of ordinary skill in the art, other drawings may be obtained based on these drawings without creative efforts.

FIG. 1 is a flowchart of a production method for producing a silicone key structure according to an embodiment of the present disclosure.

FIG. 2 is a flowchart of a method for producing a conductive member according to an embodiment of the present disclosure.

FIG. 3 is a cross-sectional schematic diagram of insulating silicone being injected into a gap to be filled according to an embodiment of the present disclosure.

FIG. 4 is a flowchart of a method for producing an insulating member according to an embodiment of the present disclosure.

FIG. 5 is a schematic structural diagram of a protective case according to an embodiment of the present disclosure.

FIG. 6 is an exploded schematic view of the protective case according to an embodiment of the present disclosure.

FIG. 7 is an exploded schematic view of the protective case from another perspective according to the embodiment of the present disclosure.

FIG. 8 is a schematic structural diagram of an electronic device assembled with a protective case in a second use state according to an embodiment of the present disclosure.

FIG. 9 is a schematic structural diagram of the electronic device assembled with the protective case in a first use state according to the embodiment of the present disclosure.

FIG. 10 is a cross-sectional schematic diagram taken along line A-A' in FIG. 5.

FIG. 11 is a schematic structural diagram of a first housing according to an embodiment of the present disclosure.

FIG. 12 is an exploded schematic view of the first housing according to an embodiment of the present disclosure.

FIG. 13 is a cross-sectional schematic diagram taken along line B-B' in FIG. 11.

FIG. 14 is a schematic structural diagram of a first base plate and a first side plate according to an embodiment of the present disclosure.

FIG. 15 is a partial cross-sectional view of a key device according to a first modified embodiment of the present disclosure.

FIG. 16 is a partial cross-sectional view of a key device according to a second modified embodiment of the present disclosure.

FIG. 17 is a partial cross-sectional view of a key device showing that a first base plate and a second base plate are connected through a connecting post engaged with a connecting groove according to a modified embodiment of the present disclosure.

FIG. 18 is a partial exploded view of a protective case according to a fourth modified embodiment of the present disclosure, where a third base plate is separated from a second side plate.

FIG. 19 is a schematic view of the protective case according to the fourth modified embodiment of the present disclosure, where the protective case is fitted on an electronic device and in a first use state, the third base plate is detached from the second side plate to expose an upper half of the electronic device.

FIG. 20 is a schematic view of the protective case according to the fourth modified embodiment of the present disclosure, where the protective case is fitted on an electronic device and in a second use state, and the third base plate is assembled to the second side plate to cover the upper half of the electronic device.

In the drawings:

1000、protective case; 100、first housing; 110、key device; 111、key structure; 1111、conductive member; 11111、first end; 11112、second end; 1112、insulating member; 11121、main body; 11122、elastic arm; 11123、buffer portion; 11124、positioning portion; 11125、venting groove; 11126、third avoidance hole; 11127、fourth avoidance hole; 112、first base plate; 1121、first avoidance hole; 1122、avoiding protrusion; 1123、avoiding recess; 1124、first connecting post; 11241、insertion groove; 1125、second slot; 113、second base plate; 1131、second avoidance hole; 1132、second connecting post; 114、key cap; 1141、limiting portion; 120、first side plate; 121、first engaging portion; 200、second housing; 201、third base plate; 2011、second engaging portion; 202、second side plate; 2021、first slot; 2000、mold; 2100、first mold plate; 2101、first groove; 2200、second mold plate; 2201、second groove; 2202、material trough; 2203、injection channel; 2300、gap to be filled; 2301、first portion; 2302、second portion; 2303、third portion; 3000、electronic device.

### DETAILED DESCRIPTION OF THE EMBODIMENTS

In order to make objectives, technical solutions, and effects of the present disclosure clearer and more definite, the present disclosure is further described in detail below with reference to accompanying drawings and embodiments. It should be understood that specific embodiments described herein are merely for explaining the present disclosure and are not intended to limit the present invention. Those skilled in the art may make modifications to the embodiments as needed that do not involve an inventive contribution after reading this specification, but as long as such modifications fall within the scope of claims of the present invention, they shall be protected by patent law.

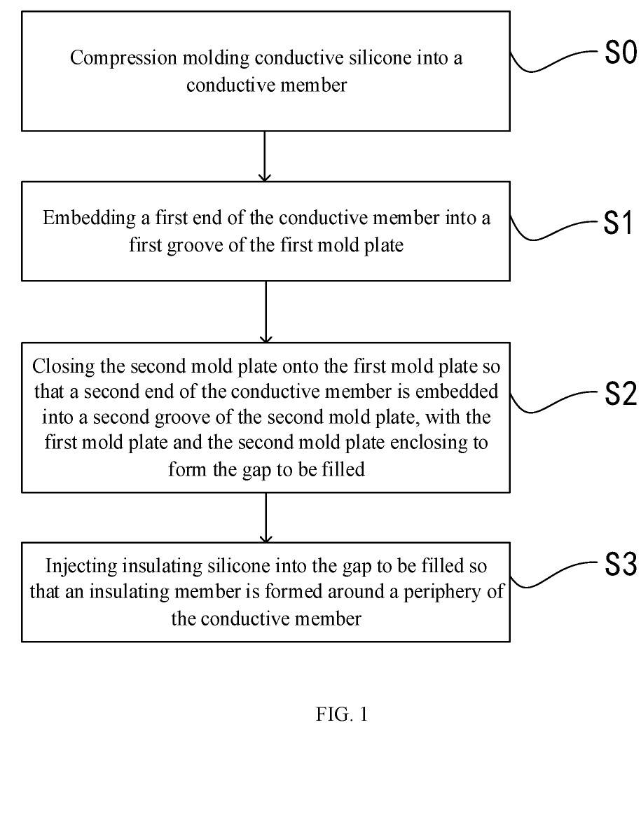

As shown in FIGS. 1-3, the present embodiment relates to a method for producing a silicone key structure. This production method involves silicone injection molding. The production method uses a first mold plate 2100 and a second mold plate 2200 that are connected together to form a gap to be filled 2300. The gap to be filled 2300 includes a first portion 2301 and a second portion 2302 communicated with the first portion 2301. An extension direction of the second portion 2302 is at an angle to an extension direction of the first portion 2301. The gap to be filled 2300 further includes a third portion 2303 communicated with the second portion 2302, and an extension direction of the third portion 2303 is at an angle to the extension direction of the second portion 2302.

The method for producing the silicone key structure specifically includes the following steps:

S0. Compression molding conductive silicone into a conductive member 1111.

S1. Embedding a first end 11111 of the conductive member 1111 into a first groove 2101 of the first mold plate 2100.

S2. Closing the second mold plate 2200 onto the first mold plate 2100 so that a second end 11112 of the conductive member 1111 is embedded into a second groove 2201 of the second mold plate 2200, with the first mold plate 2100 and the second mold plate 2200 enclosing to form the gap to be filled 2300, and the second end 11112 and the first end 11111 being located at opposite ends of the conductive member 1111 respectively.

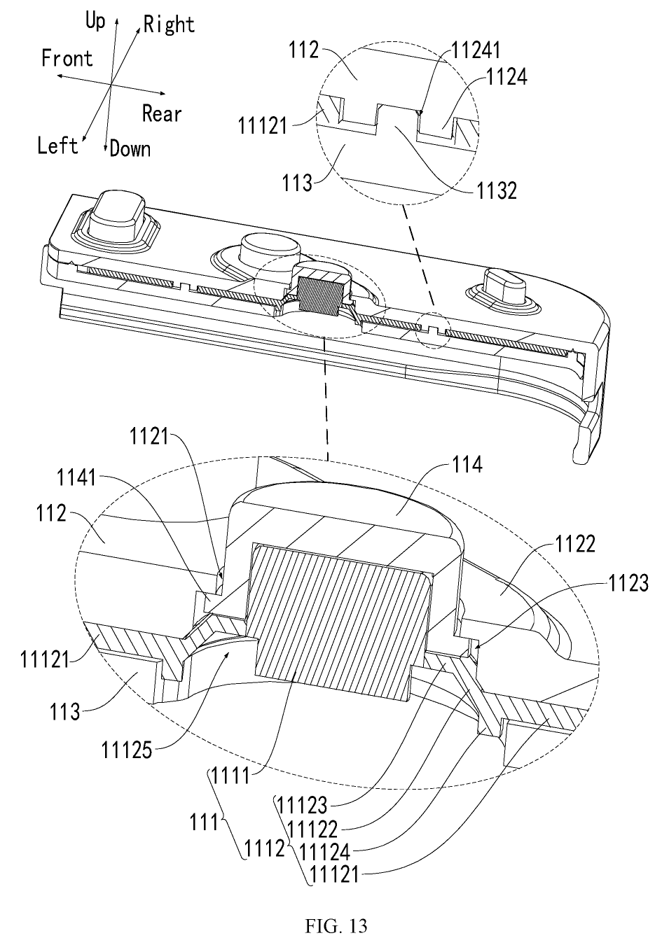

S3. Injecting insulating silicone into the gap to be filled 2300 so that an insulating member 1112 (shown in FIG. 13) is formed around the periphery of the conductive member 1111.

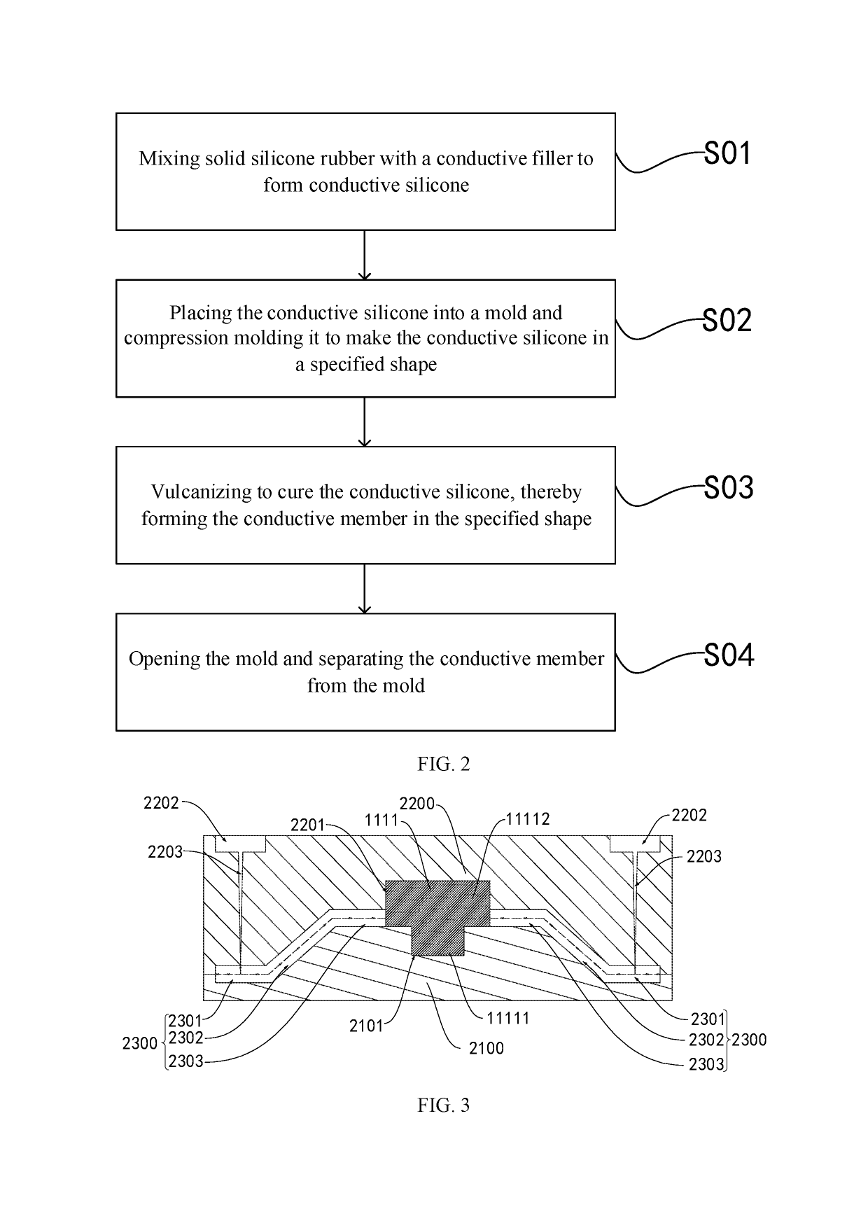

As shown in FIG. 2, step S0 specifically includes the following sub-steps:

S01. Mixing solid silicone rubber with a conductive filler to form conductive silicone.

Specifically, the solid silicone rubber is a mixture of a base rubber and a curing agent.

In some embodiments, the solid silicone rubber further includes a reinforcing filler and processing aids. The reinforcing filler is fumed silica (SiO₂). The processing aids include a structure control agent, an internal mold release agent, a plasticizer, and a color master batch. The structure control agent includes hydroxyl silicone oil or diphenylsilanediol, used to prevent agglomeration of the fumed silica and the conductive filler, improving dispersion and storage stability of the solid silicone rubber. The internal mold release agent includes zinc stearate and low molecular weight silicone oil, facilitating demolding of the conductive silicone after vulcanization and preventing tearing of the conductive silicone. The plasticizer includes methyl silicone oil, used to reduce the hardness of the solid silicone rubber and optimize key feel of the silicone key structure.

In this embodiment, the solid silicone rubber is a mixture of raw silicone rubber and a platinum-based vulcanizing agent, wherein the main component of the raw silicone rubber is methyl vinyl silicone rubber (VMQ).

Common platinum-based vulcanizing agents include Karstedt catalyst (platinum(0)-1,3-1,3-divinyl-1,1,3,3-tetramethyldisiloxane complex), Ashby catalyst (platinum(0)-cyclic vinylsiloxane complex such as Pt₂(divinyltetramethyldisiloxane)₃), Pt-Vi catalyst (platinum complex with vinyl-terminated siloxanes such as Pt-(ViSiMe₂O)₄), and platinum-alkyne complexes (platinum complexes with alkynes such as 1,3-divinyl-1,1,3,3-tetramethyldisiloxane).

The conductive filler is one of a carbon-based filler, a metal-based filler, or a mixed filler, wherein the mixed filler is a mixture of a carbon-based filler and a metal-based filler. The carbon-based filler includes carbon black and carbon nanotubes. The metal-based filler includes silver powder, silver-coated copper, and nickel powder.

S02. Placing the conductive silicone into a mold and compression molding it to make the conductive silicone in a specified shape.

In this embodiment, the specified shape is a cylinder having two sections with different diameters.

S03. Vulcanizing to cure the conductive silicone, thereby forming the conductive member 1111 in the specified shape.

In this embodiment, the conductive member 1111 is a columnar body formed by joining two cylinders of different diameters.

S04. Opening the mold and separating the conductive member 1111 from the mold.

In some embodiments, after separation from the mold, the conductive member 1111 is subjected to post-curing (secondary vulcanization) to further promote complete crosslinking and thoroughly remove vulcanization by-products (small molecules from peroxide decomposition) and other low-molecular-weight volatiles.

In other embodiments, the conductive silicone includes a base rubber, a conductive filler, and a vulcanizing agent. The base rubber is a high-consistency rubber (HCR), and the vulcanizing agent is a peroxide curing agent. Specifically, the peroxide curing agent includes DCP (dicumyl peroxide) and DBPMH (2,5-bis(tert-butyl peroxide)-2,5-dimethylhexane). In the process of mixing the conductive silicone, the base rubber is first masticated, then the conductive filler is added, followed by the vulcanizing agent.

As shown in FIG. 3, the gap to be filled 2300 in step S2 includes the first portion 2301, the second portion 2302, and the third portion 2303, which are sequentially connected. The extension direction of the second portion 2302 is at an angle to the extension direction of the first portion 2301. The extension direction of the third portion 2303 is at an angle to the extension direction of the second portion 2302, and the third portion 2303 is arranged adjacent to the conductive member 1111. Referring also to FIG. 13, the first portion 2301 is used to injection mold the main body 11121 of the insulating member 1112, the second portion 2302 is used to injection mold the elastic arm 11122 of the insulating member 1112, and the third portion 2303 is used to injection mold the buffer portion 11123 of the insulating member 1112.

Specifically, the insulating silicone is placed in a material trough 2202 and is forced under pressure into an injection channel 2203, and then into the gap to be filled 2300. When the insulating silicone is injected into the gap to be filled 2300, it sequentially passes through the first portion 2301, the second portion 2302, and the third portion 2303. The extension direction of the first portion 2301 is substantially perpendicular to an outer peripheral side of the conductive member 1111. Because the second portion 2302 is arranged at an angle to the first portion 2301, the second portion 2302 is also at an angle to the outer peripheral side of the conductive member 1111, and this angle is less than 90°. If the gap to be filled 2300 did not have the third portion 2303, and the second portion 2302 were arranged adjacent to the conductive member 1111 (i.e., the elastic arm 11122 formed by injection molding from the second portion 2302 directly connected to the conductive member 1111), then when insulating silicone is injected into the gap to be filled 2300 and passes through the second portion 2302, due to inertia, the insulating silicone would easily overflow onto the upper surface of the conductive member 1111—specifically, onto the end surface of the second end 11112 of the conductive member 1111—affecting the conductive performance of the conductive member 1111 and thereby affecting the use of the silicone key. This would prevent the user from electrically connecting to the touch screen through the conductive member 1111, and thus the user would be unable to control the touch screen via the silicone key, rendering the key's control function ineffective.

The present embodiment provides the third portion 2303 at the end of the second portion 2302 away from the first portion 2301, i.e., providing the buffer portion 11123 connected between the elastic arm 11122 and the conductive member 1111. Moreover, because the third portion 2303 is arranged at an angle to the second portion 2302, it prevents the insulating silicone, after passing through the second portion 2302, from overflowing directly onto the end surface of the second end 11112 of the conductive member 1111 due to inertia. The insulating silicone is guided by the third portion 2303, thereby adjusting its direction of movement.

Furthermore, if the gap to be filled 2300 did not have the third portion 2303, and the second portion 2302 were arranged adjacent to the conductive member 1111 (i.e., the elastic arm 11122 formed by injection molding from the second portion 2302 is directly connected to the conductive member 1111), then due to possible dimensional errors in the production of the conductive member 1111, when an oversized conductive member 1111 is embedded into the second groove 2201 of the second mold plate 2200—i.e., when the second end 11112 of the conductive member 1111 is embedded into the second groove 2201—the excess portion of the oversized conductive member 1111 would be trimmed by the edge of the second groove 2201. The trimmed portion would fall into the second portion 2302. During step S3, the trimmed conductive silicone would fuse with the insulating silicone. Since conductive silicone has weaker elasticity, this would affect the elastic performance of the elastic arm 11122 formed from the second portion 2302, potentially requiring the user to exert a greater force when pressing the key, or possibly causing the key not to rebound after being pressed, thereby affecting the user's pressing experience.

In the present embodiment, the third portion 2303 is provided at the end of the second portion 2302 facing away from the first portion 2301, i.e., the buffer portion 11123 formed by the third portion 2303 is connected between the elastic arm 11122 formed by the second portion 2302 and the conductive member 1111. As a result, any trimmed part of the conductive member 1111 falls into the third portion 2303 and fuses with the insulating silicone, affecting only the elastic performance of the buffer portion 11123 without affecting the elastic performance of the elastic arm 11122, thereby ensuring a good user pressing experience.

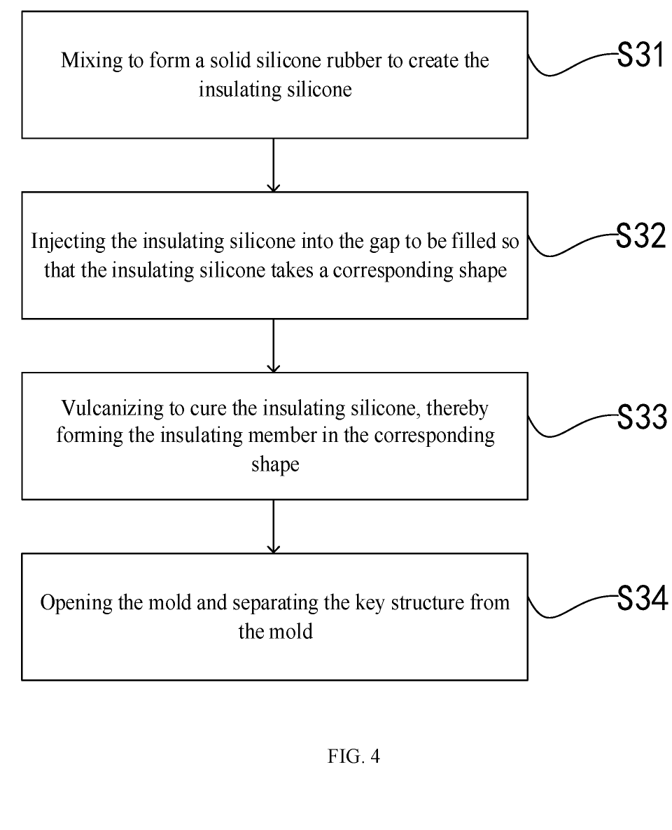

As shown in FIGS. 3 and 4, step S3 includes the following sub-steps:

S31. Mixing to form a solid silicone rubber to create the insulating silicone.

In this embodiment, the solid silicone rubber is the same as the solid silicone rubber in step S01.

In some embodiments, the solid silicone rubber further includes a reinforcing filler and processing aids. The reinforcing filler is fumed silica (SiO₂). The processing aids include a structure control agent, an internal mold release agent, a plasticizer, and a color master batch. The structure control agent includes hydroxyl silicone oil or diphenylsilanediol, used to prevent agglomeration of the fumed silica and the conductive filler, improving dispersion and storage stability of the compound. The internal mold release agent includes zinc stearate and low molecular weight silicone oil, facilitating demolding of the conductive silicone after vulcanization and preventing tearing. The plasticizer includes methyl silicone oil, used to reduce the hardness of the compound and optimize key feel.

S32. Injecting the insulating silicone into the gap to be filled 2300 so that the insulating silicone takes a corresponding shape.

The corresponding shape is the shape of the first portion 2301, the second portion 2302, and the third portion 2303. In this embodiment, the corresponding shape includes a horizontally arranged main body 11121, an elastic arm 11122 arranged at an angle to the main body 11121, and a horizontally arranged buffer portion 11123.

S33. Vulcanizing to cure the insulating silicone, thereby forming the insulating member 1112 in the corresponding shape.

Specifically, the liquid silicone in step S31 uses a platinum-based vulcanizing agent, and the liquid silicone in step S01 also uses the platinum-based vulcanizing agent. Because the vulcanizing agent in the conductive silicone is the same as the vulcanizing agent in the insulating silicone, the compatibility between the conductive silicone and the insulating silicone is improved. This ensures that during step S33, the insulating silicone bonds more firmly with the conductive member 1111, preventing the connection between the conductive member 1111 and the insulating member 1112 from being too brittle or cracking, thereby improving the yield rate of key production.

S34. Opening the mold and separating the key structure 111 from the mold 2000, where the key structure 111 includes the conductive member 1111 and the insulating member 1112.

As shown in FIGS. 3 and 13, the extension direction of the first portion 2301 is parallel to the extension direction of the third portion 2303, i.e., the extension direction of the buffer portion 11123 formed by the third portion 2303 is parallel to the extension direction of the main body 11121 formed by the first portion 2301.

Specifically, the buffer portion 11123 formed by the third portion 2303 is perpendicular to the outer axial side surface of the conductive member 1111, further preventing the insulating silicone from overflowing onto the end surface of the first end 11111 or the second end 11112 of the conductive member 1111.

More specifically, the first portion 2301 extends in a horizontal direction, and the third portion 2303 also extends in a horizontal direction. The horizontal direction includes the left-right direction and the front-back direction shown in the drawings.

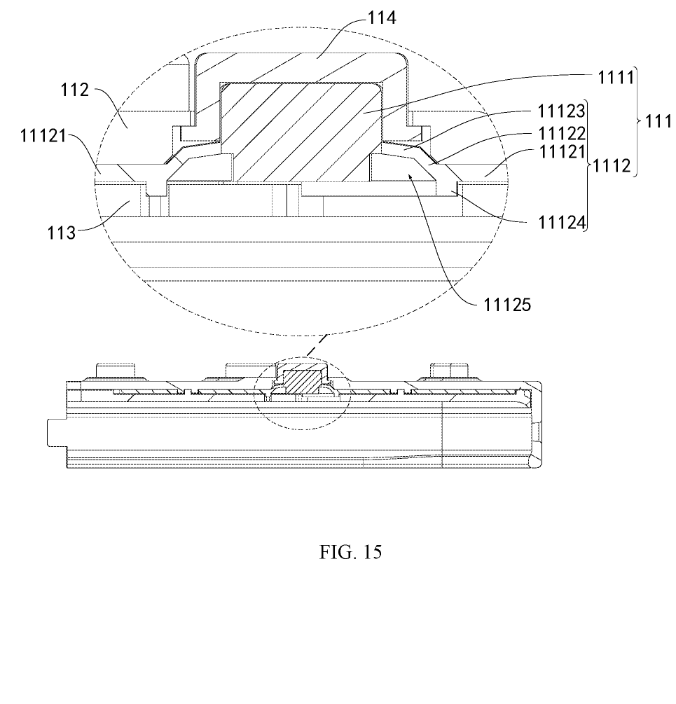

In a first modified embodiment, please refer to FIG. 15, the angle between the third portion 2303 and the second portion 2302 is greater than the angle between the second portion 2302 and the first portion 2301. In step S2, the part of the conductive member 1111 trimmed by the second groove 2201 may fall into the second portion 2302 or the first portion 2301, thereby affecting the elastic performance of the insulating member 1112.

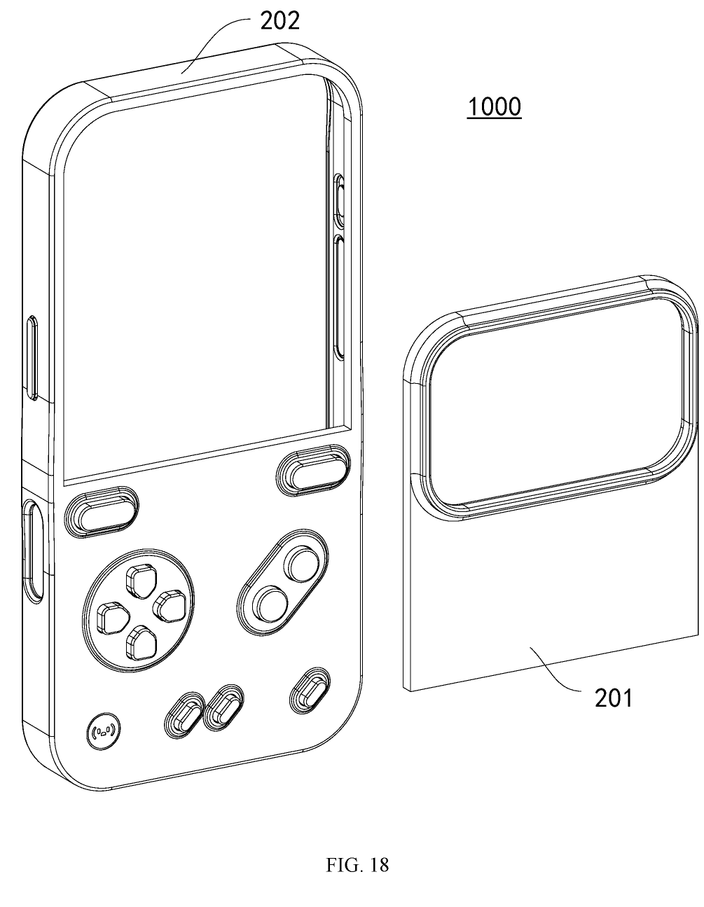

In a second modified embodiment, as shown in FIG. 16, the angle between the third portion 2303 and the second portion 2302 is smaller than the angle between the second portion 2302 and the first portion 2301. When the insulating silicone is injected into the third portion 2303, due to gravity and inertia, the insulating silicone may overflow onto the end surface of the first end 11111 of the conductive member 1111, thereby causing the conductive member 1111 to fail and affecting the yield rate of the key structure 111 production.

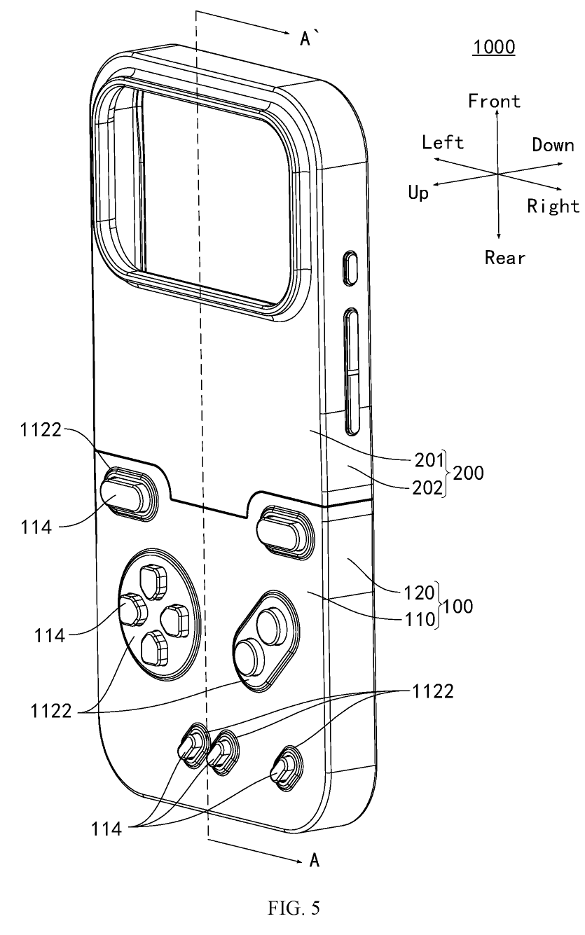

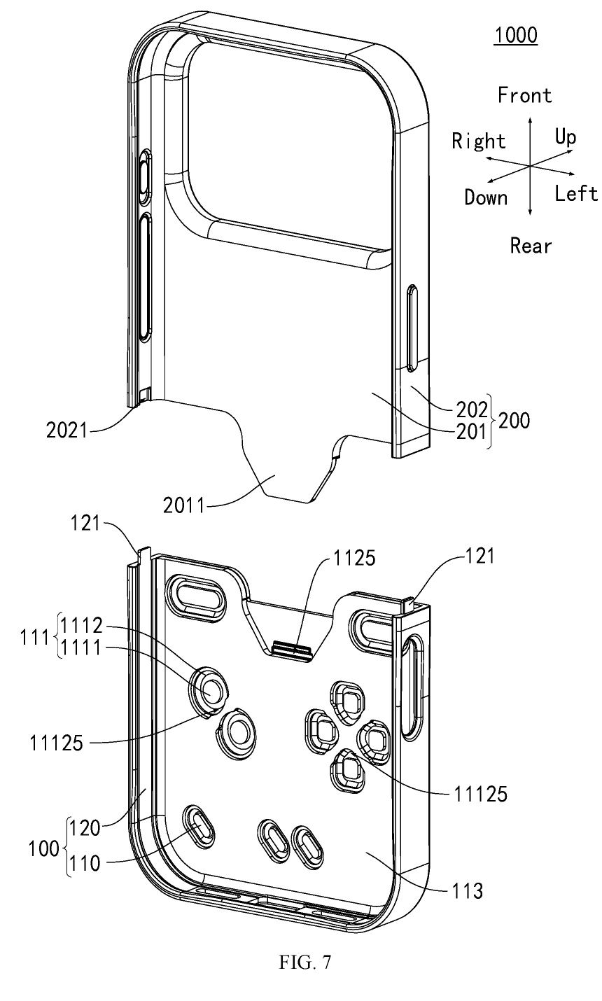

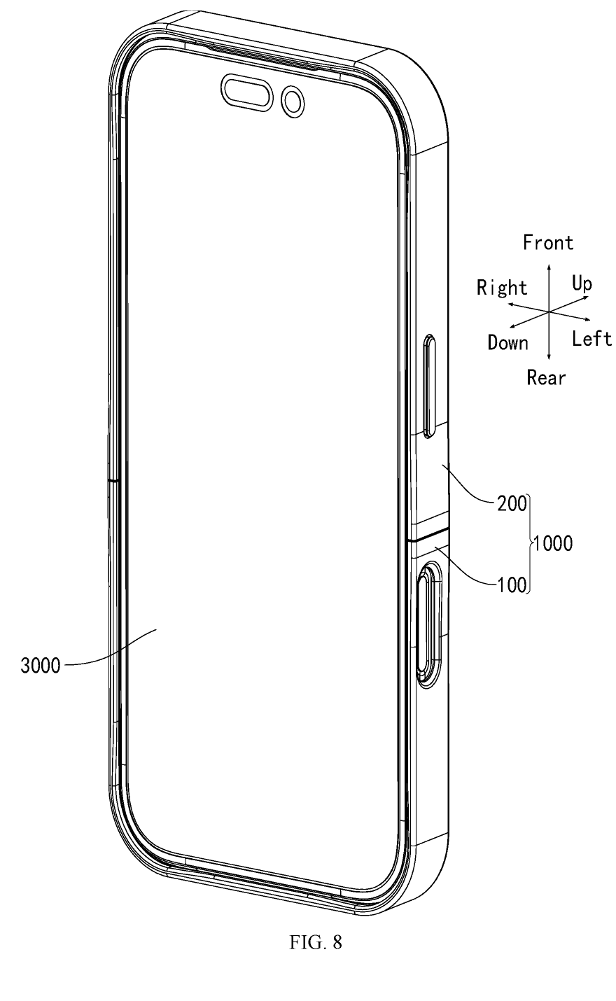

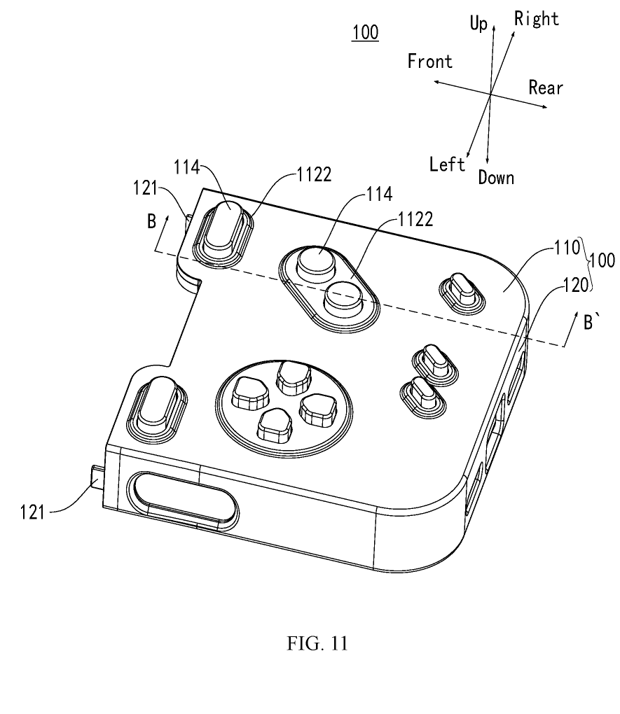

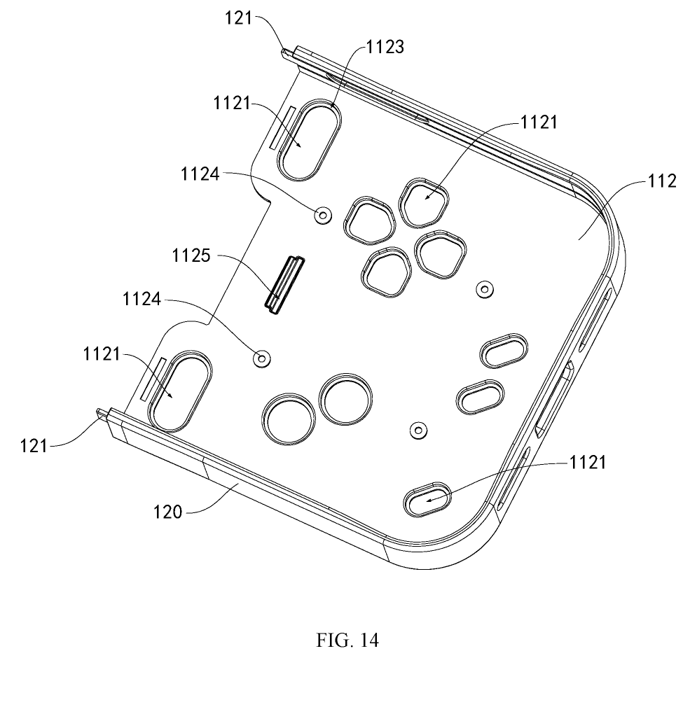

As shown in FIGS. 5-14, the key structure 111 includes the conductive member 1111 and the insulating member 1112. The conductive member 1111 is prepared using steps S01-S04, and the insulating member 1112 is prepared using steps S1-S2 and S31-S34. The insulating member 1112 includes the main body 11121, the elastic arm 11122, and the buffer portion 11123 connected in sequence. The buffer portion 11123 is connected to the conductive member 1111. The extension direction of the buffer portion 11123 is at an angle to the extension direction of the elastic arm 11122, and the extension direction of the elastic arm 11122 is at an angle to the extension direction of the main body 11121.

As shown in FIGS. 3 and 13, because the extension direction of the buffer portion 11123 is at an angle to the extension direction of the elastic arm 11122, during the injection molding process of the insulating member 1112, the insulating silicone sequentially passes through the first portion 2301, the second portion 2302, and the third portion 2303—i.e., it sequentially passes through the part of the gap to be filled that forms the main body 11121, the part of the gap to be filled that forms the elastic arm 11122, and the part of the gap to be filled that forms the buffer portion 11123. Thus, after passing through the second portion 2302 (the part of the gap to be filled that forms the elastic arm 11122), the insulating silicone does not directly connect to the conductive member 1111 but is instead received by the third portion 2303, forming the buffer portion 11123. Therefore, the insulating silicone is prevented from overflowing onto the end surface of the conductive member 1111 due to inertia—specifically, it is prevented from overflowing onto the end surface of the second end 11112 of the conductive member 1111. This ensures the conductive performance of the conductive member 1111, more specifically, ensures the conductive performance between the first end 11111 and the second end 11112 of the conductive member 1111, allowing the user to control the touch screen at the first end 11111 of the conductive member 1111 through the second end 11112.

In this embodiment, the extension direction of the buffer portion 11123 is parallel to the extension direction of the main body 11121. Specifically, the buffer portion 11123 extends in a horizontal direction, and the main body 11121 extends in the horizontal direction. The horizontal direction includes the left-right direction and the front-back direction.

In the first case, the angle formed between the buffer portion 11123 and the elastic arm 11122 is greater than the angle formed between the elastic arm 11122 and the main body 11121. In step S2, the part of the conductive member 1111 trimmed by the second groove 2201 may fall into the gap to be filled that forms the elastic arm 11122 or the main body 11121—specifically, it may fall into the second portion 2302 or the first portion 2301—thereby affecting the elastic performance of the insulating member 1112.

In the second case, the angle formed between the buffer portion 11123 and the elastic arm 11122 is smaller than the angle formed between the elastic arm 11122 and the main body 11121. During injection molding of the insulating member 1112, specifically when forming the buffer portion 11123 (i.e., when the insulating silicone fills the third portion 2303), due to gravity and inertia, the insulating silicone may overflow onto the end surface of the first end 11111 of the conductive member 1111, thereby causing the conductive member 1111 to fail and affecting the yield rate of the key structure 111 production.

As shown in FIGS. 3 and 10-14, an embodiment of the present disclosure further provides a key device 110. The key device 110 includes the key structure 111 of the above embodiments, a first base plate 112, and a second base plate 113. The main body 11121 of the key structure 111 is clamped between the first base plate 112 and the second base plate 113. The first base plate 112 is provided with the first avoidance hole 1121. The first avoidance hole 1121 is used to avoid the conductive member 1111 of the key structure 111 in its natural state. Specifically, it is to avoid the second end 11112 of the conductive member 1111, so as to expose the second end 11112 of the conductive member 1111 for user pressing. The second base plate 113 is provided with a second avoidance hole 1131. The second avoidance hole 1131 is used to avoid the conductive member 1111 in its pressed state. Specifically, it is to avoid the first end 11111 of the conductive member 1111, so that the first end 11111 of the conductive member 1111 can abut against a touch screen, thereby forming an electrical connection path among the user, the conductive member 1111, and the touch screen, allowing the user to control the touch screen by pressing the conductive member 1111.

The natural state refers to a state in which the user is not pressing the conductive member 1111, and the elastic arm 11122 maintains its original shape to support the conductive member 1111, so that the second end 11112 of the conductive member 1111 protrudes through the first avoidance hole 1121. The pressed state refers to a state in which the user presses the conductive member 1111, and the elastic arm 11122 deforms under force, causing the conductive member 1111 to move downward, thereby making the first end 11111 of the conductive member 1111 protrude through the second avoidance hole 1131, so that the end surface of the first end 11111 of the conductive member 1111 abuts against the touch screen, forming an electrical connection path among the user, the conductive member 1111, and the touch screen, allowing the user to control the touch screen by pressing the conductive member 1111. When the user releases the pressed conductive member 1111, the state switches from the pressed state to the natural state, and the elastic arm 11122 returns to its original shape to support the conductive member 1111, causing the second end 11112 of the conductive member 1111 to protrude through the first avoidance hole 1121 for the user's next press.

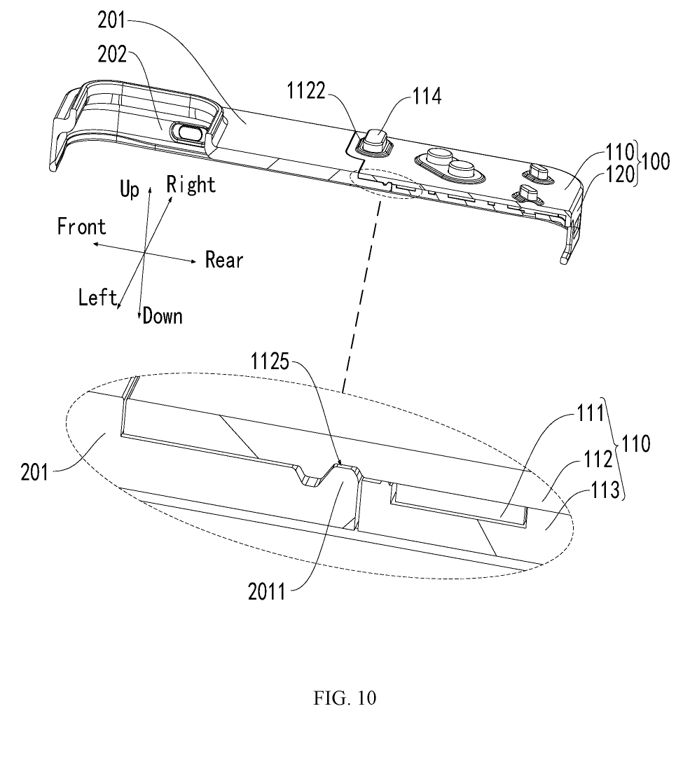

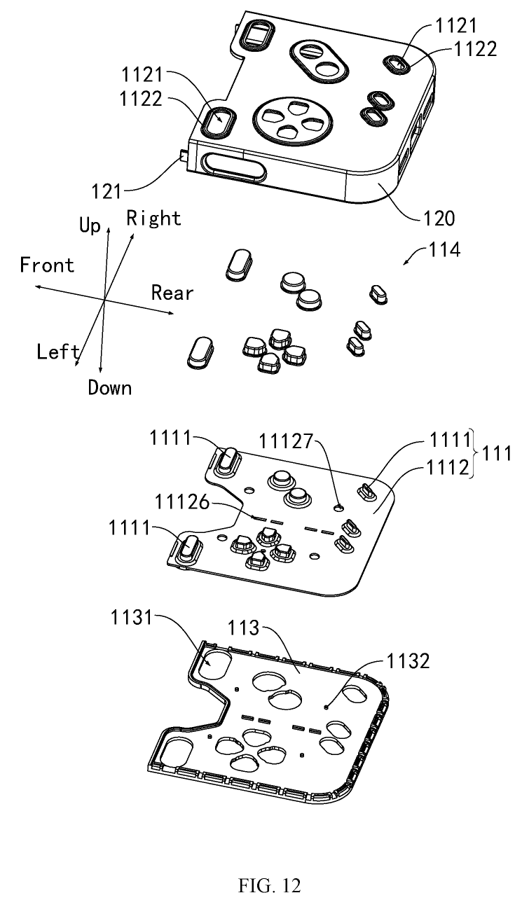

As shown in FIGS. 10 and 12, in this embodiment, the first base plate 112 and the second base plate 113 are connected by ultrasonic welding.

Specifically, the main body 11121 is provided with a third avoidance hole 11126. The third avoidance hole 11126 is used to avoid an ultrasonic welding rib of either the first base plate 112 or the second base plate 113, so that when the first base plate 112 and the second base plate 113 clamp the main body 11121 of the key structure 111, the ultrasonic welding rib of one of the first base plate 112 or the second base plate 113 connects with the other of the first base plate 112 or the second base plate 113, and under ultrasonic welding treatment, the first base plate 112 and the second base plate 113 are ultrasonically welded together, thereby clamping the main body 11121 of the key structure 111 between the first base plate 112 and the second base plate 113.

More specifically, the dimension of the first base plate 112 in the horizontal direction is larger than the dimension of the main body 11121 in the horizontal direction, and the dimension of the second base plate 113 in the horizontal direction is larger than the dimension of the main body 11121 in the horizontal direction. The portion of the first base plate 112 extending beyond the main body 11121 is ultrasonically welded to the portion of the second base plate 113 extending beyond the main body 11121, so as to clamp the edge of the main body 11121 between the first base plate 112 and the second base plate 113.

In other embodiments, the connection between the first base plate 112 and the second base plate 113 can be one or a combination of snapping, screwing, adhesive bonding, or heat staking.

As shown in FIGS. 12-14, in this embodiment, the first base plate 112 is provided with a first connecting post 1124, and the second base plate 113 is provided with a second connecting post 1132. The main body 11121 is provided with a fourth avoidance hole 11127. The fourth avoidance hole 11127 is used to avoid the first connecting post 1124 and the second connecting post 1132. The first connecting post 1124 is provided with an insertion groove 11241, and the second connecting post 1132 is inserted into the insertion groove 11241 of the first connecting post 1124, thereby connecting the first base plate 112 and the second base plate 113, aligning the first avoidance hole 1121 with the second avoidance hole 1131, and facilitating alignment of the conductive member 1111 with the first avoidance hole 1121 and the second avoidance hole 1131.

In other embodiments, the second connecting post 1132 is provided with an insertion groove 11241, and the first connecting post 1124 is inserted into the insertion groove 11241 of the second connecting post 1132, thereby connecting the first base plate 112 and the second base plate 113, aligning the first avoidance hole 1121 with the second avoidance hole 1131, and facilitating alignment of the conductive member 1111 with the first avoidance hole 1121 and the second avoidance hole 1131.

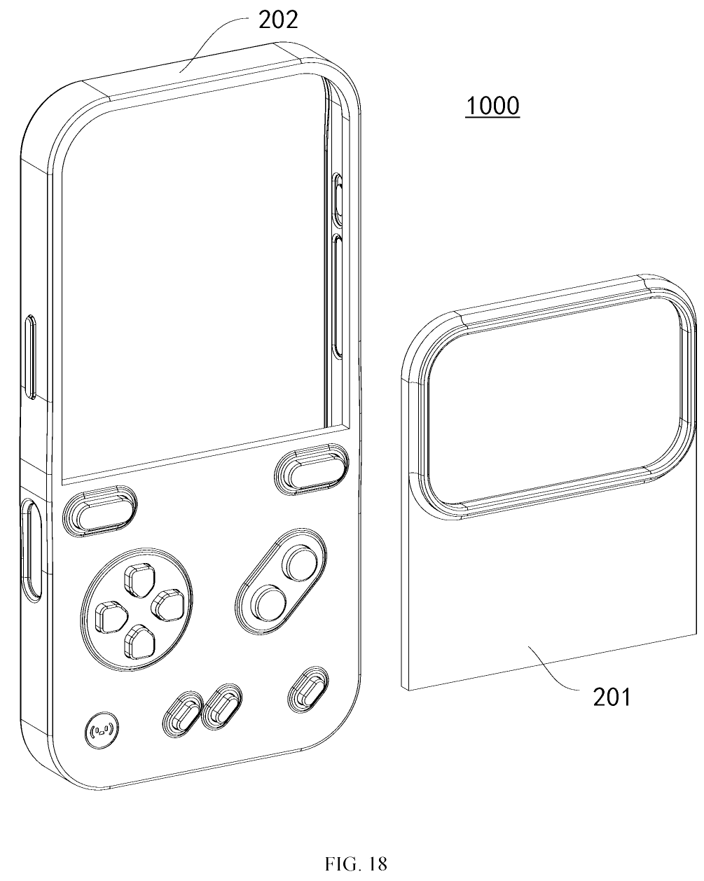

In other embodiments, please refer to FIG. 17, one of the first base plate 112 and the second base plate 113 is provided with a connecting post 1132, and the other of the first base plate 112 and the second base plate 113 is provided with a connecting groove 1126. The main body 11121 is provided with a fourth avoidance hole 11127. The fourth avoidance hole 11127 is used to avoid the connecting post, so that when the first base plate 112 and the second base plate 113 together clamp the main body 11121, the connecting post passes through the fourth avoidance hole 11127 and is inserted into the connecting groove, thereby connecting the first base plate 112 and the second base plate 113, aligning the first avoidance hole 1121 with the second avoidance hole 1131, and facilitating alignment of the conductive member 1111 with the first avoidance hole 1121 and the second avoidance hole 1131.

As shown in FIGS. 5-13, the key device 110 is used for a touch screen of an electronic device 3000. Specifically, the second base plate 113 is adjacent to the touch screen, and more specifically, the side of the second base plate 113 away from the first base plate 112 abuts against the surface of the touch screen. Both the first base plate 112 and the second base plate 113 are made of non-conductive materials. The side of the first base plate 112 facing away from the second base plate 113 is provided with an avoiding protrusion 1122, and the side of the first base plate 112 facing the second base plate 113 is provided with an avoiding recess 1123. The first avoidance hole 1121 is arranged in the avoiding protrusion 1122 and communicates with the avoiding recess 1123. The avoiding recess 1123 is used to accommodate the elastic arm 11122 and at least a portion of the buffer portion 11123.

Compared with an embodiment without the avoiding protrusion 1122, the movement path of the conductive member 1111 in the vertical direction mainly relies on the thicknesses of the first base plate 112, the main body 11121, and the second base plate 113. Since the first base plate 112 and the second base plate 113 together clamp the main body 11121, the total thickness of these three components is limited. As a result, when the user presses the conductive member 1111, the conductive member 1111 moves a short distance in the vertical direction before abutting the touch screen, affecting the user's pressing experience. If the thickness of the first base plate 112 or the second base plate 113 is increased, the weight of the key device 110 increases, making it less portable for the user, and production costs also rise. The inclusion of the avoiding protrusion 1122 increases the distance from the outer surface of the first base plate 112 to the touch screen—i.e., the distance from the side of the first base plate 112 facing away from the second base plate 113 to the touch screen—thereby increasing the movement space for the conductive member 1111 and the deformation space for the elastic arm 11122, thus lengthening the movement path of the conductive member 1111 in the vertical direction and improving the user's experience when pressing the key device 110.

As shown in FIGS. 3 and 13, the main body 11121 is provided with a positioning portion 11124. The positioning portion 11124 is arranged adjacent to the elastic arm 11122, specifically on the side of the main body 11121 adjacent to the second base plate 113. The positioning portion 11124 is embedded in the second avoidance hole 1131 and extends along the edge of the second avoidance hole 1131. When the user presses the conductive member 1111, the elastic arm 11122 deforms accordingly. If the user presses not vertically downward but obliquely downward, it may easily cause the region where the first end 11111 of the conductive member 1111 abuts the touch screen to deviate from the originally preset area, leading to failure or error in the user's control of the touch screen. Through arrangement of the positioning portion 11124, when the conductive member 1111 shifts laterally due to an oblique downward press, the end of the elastic arm 11122 adjacent to the main body 11121 is restrained by the positioning portion 11124. Specifically, the positioning portion 11124 abuts against the wall of the second avoidance hole 1131, providing a supporting force opposite to the lateral shift direction, causing the elastic arm 11122 to compress and deform, thereby providing greater elastic force to reduce the lateral shift of the conductive member 1111.

The position of the conductive member 1111 is arranged according to the preset region of the touch screen, so that when the user presses the conductive member 1111, the conductive member 1111 can abut the corresponding preset region of the touch screen, thereby controlling the touch screen accordingly.

As shown in FIGS. 13, 15 and 16, the positioning portion 11124 can be arranged at the junction of the elastic arm 11122 and the main body 11121. The positioning portion 11124 includes an upper end connected to the elastic arm 11122 and the main body 11121, and a lower end extending toward the second base plate 113 in a direction substantially perpendicular to the main body 11121. With this arrangement, the positioning portion 11124 can better fit the inner wall of the second avoidance hole 1131, thereby more effectively preventing lateral displacement of the conductive member 1111.

In some embodiments, as shown in FIG. 17, the positioning portion 11124 includes an upper end and a lower end, wherein the upper end of the positioning portion 11124 is connected to the main body 11121, and the lower end of the positioning portion 11124 is connected to the end of the elastic arm 11122 facing away from the buffer portion 11123. The lower end extends toward the second base plate 113 in a direction substantially perpendicular to the main body 11121. Compared with the embodiments where the elastic arm 11122 is directly connected to the main body 11121 and the upper end of the positioning portion 11124 is connected to the main body 11121 (as shown in FIGS. 13 and 15-16), the arrangement in which the upper and lower ends of the positioning portion 11124 are respectively connected to the main body 11121 and the elastic arm 11122 increases the length of the elastic arm 11122 in the vertical direction, thereby increasing the elastic force provided by the elastic arm 11122 in the pressed state, and thus improving the user's experience when pressing the key device 110.

When the key structure 111 is pressed, the space enclosed by the touch screen, the positioning portion 11124, the elastic arm 11122, and the conductive member 1111 is evacuated and forms a sealed space. Due to air pressure, the elastic arm 11122 cannot return to its original shape—i.e., it remains in the pressed state and cannot switch to the natural state—causing the conductive member 1111 to adhere to the touch screen and making it unavailable for the user's next press.

As shown in FIG. 13, the positioning portion 11124 is provided with a venting groove 11125. The provision of the venting groove 11125 prevents formation of the sealed space enclosed by the touch screen, the positioning portion 11124, the elastic arm 11122, and the conductive member 1111, thereby preventing the conductive member 1111 from adhering to the touch screen, ensuring that the elastic arm 11122 can return from its deformed pressed state to its natural state, and thus ensuring a good user experience.

As shown in FIGS. 5-6 and 9-13, a keycap 114 is fitted over the second end 11112 of the conductive member 1111. The keycap 114 is provided with a limiting portion 1141 extending in the horizontal direction. In the natural state, the limiting portion 1141 abuts against the side of the first base plate 112 facing the second base plate 113—specifically, the limiting portion 1141 abuts against the outer edge of the first avoidance hole 1121—thereby preventing the keycap 114 from coming out of the first avoidance hole 1121 and avoiding the keycap 114 from detaching from the conductive member 1111 due to inertia during the transition from the pressed state to the natural state.

The keycap 114 is made of a conductive material, so that when the user presses the keycap 114, an electrical connection path to the touch screen is formed through the keycap 114 and the conductive member 1111, thereby controlling the touch screen.

As shown in FIGS. 5-14, an embodiment of the present disclosure further provides a protective case 1000 for an electronic device 3000. The protective case 1000 is configured to be fitted over the outside of the electronic device 3000. The protective case 1000 includes the key device 110 described above. In a first use state, the portion of the protective case 1000 provided with the key device 110 covers the side of the electronic device 3000 on which the touch screen is arranged, i.e., the key device 110 covers the front side of the electronic device 3000, allowing the user to press the key device 110 to control the touch screen. In a second use state, the portion of the protective case 1000 provided with the key device 110 covers the side of the electronic device 3000 without the touch screen, i.e., the key device 110 covers the back side of the electronic device 3000, to protect the electronic device 3000.

Specifically, the protective case 1000 includes the first base plate 112 and a side plate, wherein the first base plate 112 covers the front or back side of the electronic device 3000, and the side plate is used to cover the side surfaces of the electronic device 3000.

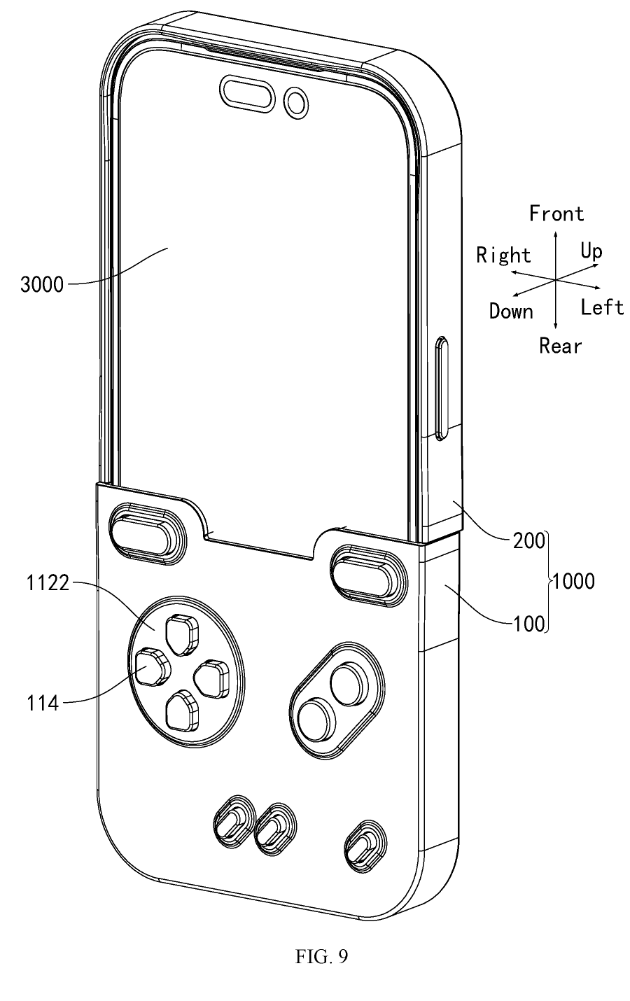

As shown in FIGS. 8-9, in this embodiment, the protective case 1000 further includes a first housing 100 and a second housing 200. The first housing 100 and the second housing 200 are detachably connected. The key device 110 is arranged on the first housing 100. In the first use state, the first housing 100 at least partially covers the side of the electronic device 3000 on which the touch screen is arranged, i.e., the portion of the first housing 100 provided with the key device 110 covers the side of the electronic device 3000 on which the touch screen is arranged, so that the key device 110 covers the front side of the electronic device 3000, allowing the user to press the key device 110 to control the touch screen. In the second use state, the portion of the first housing 100 provided with the key device 110 covers the side of the electronic device 3000 without the touch screen, i.e., the key device 110 covers the back side of the electronic device 3000, to protect the electronic device 3000.

As shown in FIGS. 8-9, one of the first housing 100 and the second housing 200 is provided with an engaging portion, and the other of the first housing 100 and the second housing 200 is provided with a slot. The engaging portion engages with the slot to detachably connect the first housing 100 and the second housing 200.

Specifically, in the first use state, the second housing 200 covers the back side of the electronic device 3000, and the first housing 100 covers the front side of the electronic device 3000, exposing a portion of the touch screen for the user to view. Specifically, the upper half of the touch screen is exposed for the user to view. A first side plate 120 of the first housing 100 is detachably connected to a second side plate 202 of the second housing 200. In the second use state, the first housing 100 and the second housing 200 together cover the back side of the electronic device 3000 to protect the electronic device 3000.

In other embodiments, the connection between the first housing 100 and the second housing 200 is achieved by one or a combination of adhesive bonding, hook-and-loop fastening (Velcro), and snap-fit engagement.

As shown in FIGS. 5-6 and 11-14, the engaging portion includes a first engaging portion 121. The first engaging portion 121 is provided on the side plate of one of the first housing 100 and the second housing 200. The slot includes a first slot 2021. The first slot 2021 is provided on the side plate of the other of the first housing 100 and the second housing 200.

In this embodiment, the first engaging portion 121 is provided on the side plate of the first housing 100, i.e., the first engaging portion 121 is provided on the first side plate 120. The first slot 2021 is provided on the side plate of the second housing 200, i.e., the first slot 2021 is provided on the second side plate 202. The first engaging portion 121 engages with the first slot 2021, making the first housing 100 and the second housing 200 detachably connected.

In other embodiments, the first engaging portion 121 is provided on the side plate of the second housing 200, i.e., the first engaging portion 121 is provided on the second side plate 202. The first slot 2021 is provided on the side plate of the first housing 100, i.e., the first slot 2021 is provided on the first side plate 120. The first engaging portion 121 engages with the first slot 2021, making the first housing 100 and the second housing 200 detachably connected.

In this embodiment, the first engaging portion 121 has no latching tongue. When the first engaging portion 121 is inserted into the first slot 2021, it fits tightly with the first slot 2021, making the first housing 100 and the second housing 200 detachably connected.

In other embodiments, the first engaging portion 121 is provided with a latching tongue for engaging with the first slot 2021, making the first housing 100 and the second housing 200 detachably connected.

As shown in FIGS. 5-6 and 11-14, the engaging portion includes a second engaging portion 2011. The second engaging portion 2011 is provided on the base plate of one of the first housing 100 and the second housing 200. The slot includes a second slot 1125. The second slot 1125 is provided on the base plate of the other of the first housing 100 and the second housing 200.

In this embodiment, the second engaging portion 2011 is provided on the base plate of the first housing 100, i.e., the second engaging portion 2011 is provided on the first base plate 112. The second slot 1125 is provided on the base plate of the second housing 200, i.e., the second slot 1125 is provided on the third base plate 201. The second engaging portion 2011 engages with the second slot 1125, making the first housing 100 and the second housing 200 detachably connected.

In other embodiments, the second engaging portion 2011 is provided on the base plate of the second housing 200, i.e., the second engaging portion 2011 is provided on the third base plate 201. The second slot 1125 is provided on the base plate of the first housing 100, i.e., the second slot 1125 is provided on the first base plate 112. The second engaging portion 2011 engages with the second slot 1125, making the first housing 100 and the second housing 200 detachably connected.

In this embodiment, the first housing 100 includes the key device 110 and the first side plate 120, and the key device 110 includes the first base plate 112. The first base plate 112 covers the front or back side of the electronic device 3000, and the first side plate 120 is used to cover the side surfaces of the electronic device 3000. The second housing 200 includes a third base plate 201 and a second side plate 202. The third base plate 201 covers the back side of the electronic device 3000, and the second side plate 202 is used to cover the side surfaces of the electronic device 3000. The first side plate 120 and the second side plate 202 are detachably connected, making the first housing 100 and the second housing 200 detachably connected.

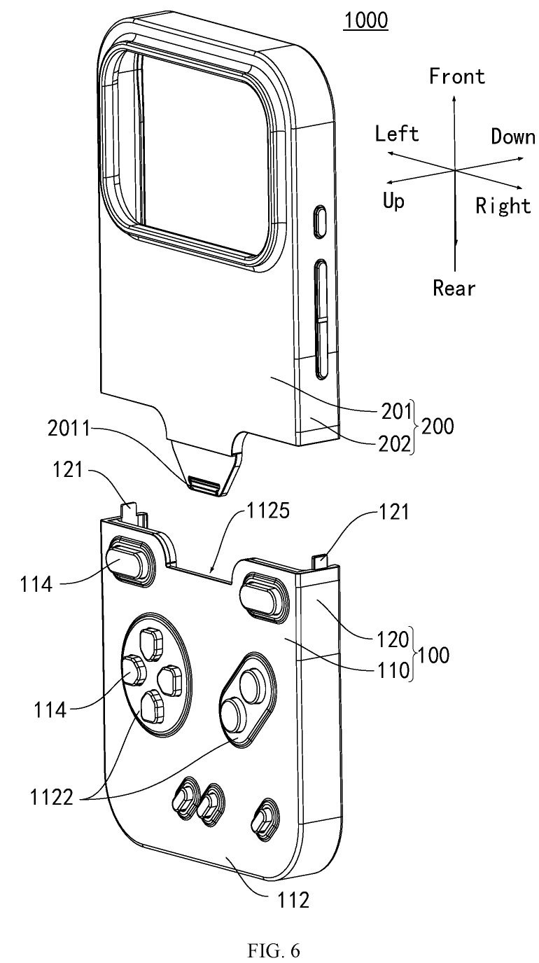

As shown in FIGS. 6-10, one of the first side plate 120 and the second side plate 202 is provided with the first engaging portion 121, and the other of the first side plate 120 and the second side plate 202 is provided with the first slot 2021. When the first engaging portion 121 is inserted into the first slot 2021, the first side plate 120 and the second side plate 202 are detachably connected.

In other embodiments, the connection between the first side plate 120 and the second side plate 202 is achieved by one or a combination of adhesive bonding, hook-and-loop fastening (Velcro), and snap-fit engagement.

As shown in FIGS. 6-10, in this embodiment, the first base plate 112 is provided with the second slot 1125, and the third base plate 201 is provided with the second engaging portion 2011. In the second use state, the second engaging portion 2011 engages with the second slot 1125, improving the connection stability between the first housing 100 and the second housing 200 and preventing the first housing 100 or the second housing 200 from coming off.

In a third modified embodiment, compared with the above embodiments of the present disclosure, the first housing 100 and the second housing 200 in this modified embodiment are integrally formed, and the second housing 200 includes only the second side plate 202, without the third base plate 201. In the first use state, the first base plate 112 covers the front side of the electronic device 3000, specifically the lower half of the front side of the electronic device 3000. Because the third base plate 201 is not provided, the upper half of the front side of the electronic device 3000 is directly exposed for the user to view directly. In the second use state, because the third base plate 201 is not provided, the upper half of the back side of the electronic device 3000 is directly exposed, which may easily cause the upper half of the back side of the electronic device 3000 to be scratched or damaged.

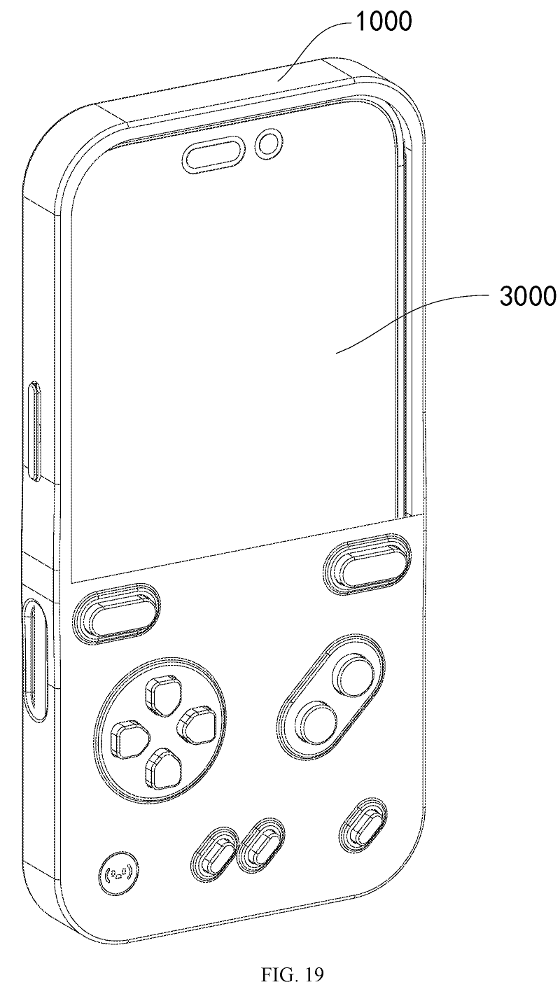

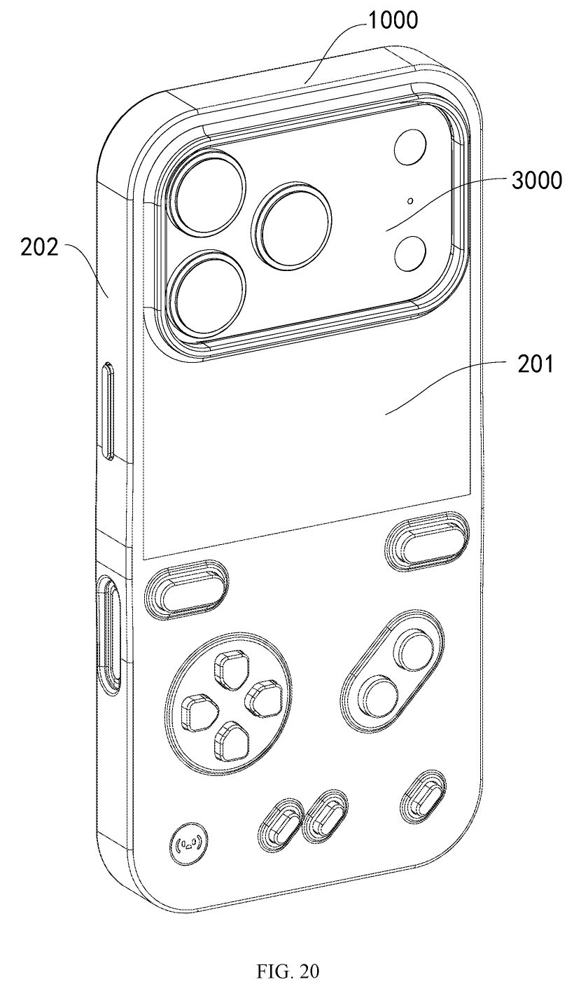

In a fourth modified embodiment, as shown in FIG. 18, compared with the third modified embodiment, this modified embodiment additionally includes the third base plate 201, and the third base plate 201 is detachably connected to the second side plate 202. In the first use state, as shown in FIG. 19, the third base plate 201 is detached from the second side plate 202 to directly expose the upper half of the front side of the electronic device 3000, i.e., the upper half of the touch screen, for the user to view and use. In the second use state, as shown in FIG. 20, the third base plate 201 is assembled to the second side plate 202, so that the third base plate 201 covers the upper half of the electronic device 3000 to fully protect the electronic device 3000.

In a fifth modified embodiment, compared with the embodiment of the present disclosure, the second housing 200 is made of a transparent or semi-transparent material, so that in the first use state, the user can directly view and use the upper half of the front side of the electronic device 3000 through the second housing 200—specifically, view and use the upper half of the touch screen through the third base plate 201.

Although specific descriptions have been provided in conjunction with the accompanying drawings and embodiments in the present disclosure, it is understood that the above descriptions do not limit this invention in any form. Those skilled in the art can make deformations and changes to the present disclosure according to needs without deviating from the essence and scope of this invention, and these deformations and changes all fall within the scope of this invention.

What is claimed is:

1. A key structure, comprising:
a conductive member; and
an insulating member surrounding the conductive member;
wherein the insulating member comprises a main body, an elastic arm, and a buffer portion connected in sequence, the buffer portion is connected to the conductive member, an extension direction of the buffer portion is arranged at an angle to an extension direction of the elastic arm, and the extension direction of the elastic arm is arranged at an angle to an extension direction of the main body.

2. The key structure according to claim 1, wherein the extension direction of the buffer portion is parallel to the extension direction of the main body.

3. A key device, comprising:
a first base plate;
a second base plate; and
a key structure, comprising a conductive member and an insulating member surrounding the conductive member, the insulating member comprising a main body, an elastic arm, and a buffer portion connected in sequence, the buffer portion being connected to the conductive member, an extension direction of the buffer portion being arranged at an angle to an extension direction of the elastic arm, and the extension direction of the elastic arm being arranged at an angle to an extension direction of the main body;
wherein the main body of the key structure is arranged between the first base plate and the second base plate, the first base plate is provided with a first avoidance hole configured to avoid the conductive member of the key structure in a natural state, and the second base plate is provided with a second avoidance hole configured to avoid the conductive member in a pressed state.

4. The key device according to claim 3, wherein the key device is used for a touch screen, the second base plate is arranged adjacent to the touch screen, a side of the first base plate facing away from the second base plate is formed with an avoiding protrusion extending from an outer surface of the first base plate in a direction away from the second base plate, and the first avoidance hole is arranged in the avoiding protrusion.

5. The key device according to claim 3, wherein a side of the first base plate adjacent to the second base plate is formed with an avoiding recess communicated with the first avoidance hole, and the avoiding recess is configured to receive the elastic arm and at least part of the buffer portion.

6. The key device according to claim 3, wherein the first base plate and the second base plate are connected by ultrasonic welding, and the main body of the key structure is provided with a third avoidance hole for accommodating a welding rib used in the ultrasonic welding.

7. The key device according to claim 3, wherein the key device is used for a touch screen, the main body is provided with a positioning portion, the positioning portion is embedded into the second avoidance hole and extends along an edge of the second avoidance hole, for preventing lateral displacement of the conductive member.

8. The key device according to claim 7, wherein the positioning portion is provided with a venting groove.

9. The key device according to claim 7, wherein the positioning portion comprises an upper end connected to the main body and a lower end connected to the elastic arm.

10. The key device according to claim 3, wherein one of the first base plate and the second base plate is provided with a connecting post, and another of the first base plate and the second base plate is provided with a connecting groove, the connecting post cooperating with the connecting groove such that the conductive member is aligned with the first avoidance hole and the second avoidance hole.

11. The key device according to claim 3, wherein the first base plate is provided with a first connecting post, the second base plate is provided with a second connecting post, one of the first connecting post and the second connecting post is provided with an insertion groove, and another of the first connecting post and the second connecting post is inserted into the insertion groove.

12. The key device according to claim 11, wherein the main body is provided with a fourth avoidance hole for allowing one of the first connecting post and the second connecting post to pass through the main body and be inserted into the insertion groove of another of the first connecting post and the second connecting post.

13. The key device according to claim 3, wherein a key cap is sleeved on an end of the conductive member facing away from the second base plate.

14. The key device according to claim 3, wherein the extension direction of the buffer portion is parallel to the extension direction of the main body.

15. A protective case for being sleeved on an outside of an electronic device, comprising:
a first housing;
a second housing detachably connected to the first housing; and
a key device according to claim 3 arranged on the first housing,
wherein, in a first use state, the first housing at least partially covers a side of the electronic device provided with a touch screen, so that the key device is capable of controlling the touch screen.

16. The protective case according to claim 15, wherein, in a second use state, a part of the first housing provided with the key device covers a side of the electronic device facing away from the touch screen.

17. The protective case according to claim 15, wherein a first side plate of the first housing is detachably connected to a second side plate of the second housing.

18. A key production method, using a first mold plate and a second mold plate to enclose and form a gap to be filled, the gap to be filled comprising a first portion and a second portion communicated with the first portion, an extension direction of the second portion being arranged at an angle to an extension direction of the first portion, wherein the gap to be filled further comprises a third portion communicated with the second portion, an extension direction of the third portion being arranged at an angle to the extension direction of the second portion;
the key production method comprises the following steps:
18S1. embedding a first end of a conductive member into a first groove of the first mold plate;
18S2. covering the second mold plate onto the first mold plate such that a second end of the conductive member is embedded into a second groove of the second mold plate, wherein the first mold plate and the second mold plate are connected to form the gap to be filled, and wherein the second end and the first end are respectively located at two opposite ends of the conductive member;
18S3. injecting insulating silicone rubber into the gap to be filled such that an insulating member is formed around the conductive member;
wherein the third portion is arranged adjacent to the conductive member, the insulating member comprises a main body, an elastic arm, and a buffer portion connected in sequence, wherein the first portion is used for injection molding the main body of the insulating member, the second portion is used for injection molding the elastic arm of the insulating member, and the third portion is used for injection molding the buffer portion of the insulating member; the buffer portion is connected to the conductive member, an extension direction of the buffer portion is arranged at an angle to an extension direction of the elastic arm, and the extension direction of the elastic arm is arranged at an angle to an extension direction of the main body.

19. The key production method according to claim 18, wherein the extension direction of the first portion is parallel to the extension direction of the third portion.

20. The key production method according to claim 18, wherein the conductive member and the insulating member use the same vulcanizing agent.
